(19) United States
(12) Patent Application Publication
(10) Pub. No.: US 2024/0119740 A1
(43) Pub. Date: Apr. 11, 2024

(54) METHOD AND APPARATUS WITH LANE LINE DETERMINATION

(71) Applicant: SAMSUNG ELECTRONICS CO., LTD., Suwon-si (KR)

(72) Inventors: Seho SHIN, Suwon-si (KR); Jahoo KOO, Suwon-si (KR); Yonggonjong PARK, Suwon-si (KR)

(73) Assignee: SAMSUNG ELECTRONICS CO., LTD., Suwon-si (KR)

(21) Appl. No.: 18/184,163

(22) Filed: Mar. 15, 2023

(30) Foreign Application Priority Data
Oct. 7, 2022 (KR) 10-2022-0128435

(51) Int. Cl. G06V 20/56; G06V 20/58

(52) U.S. Cl. CPC G06V 20/588; G06V 20/582

(57) ABSTRACT

A processor-implemented method with lane line determination includes: determining, from an input image, road feature information comprising a surrounding object and a road surface marking comprising a lane line; matching the road feature information to lane lines of a driving road on which a vehicle is driving; detecting whether there is a change in a road structure based on a result of the matching, wherein the change in the road structure comprises any one or any combination of any two or more of a change of the lane line, a loss of the lane line, and a change of a road sign; and based on whether the change in the road structure is detected, determining lane line information of the driving road by using information on the surrounding object.

### CROSS-REFERENCE TO RELATED APPLICATIONS

This application claims the benefit under 35 USC § 119(a) of Korean Patent Application No. 10-2022-0128435, filed on Oct. 7, 2022 in the Korean Intellectual Property Office, the entire disclosure of which is incorporated herein by reference for all purposes.

### BACKGROUND

### 1 Field

The following description relates to a method and apparatus with lane line determination.

### 2. Description of Related Art

Technologies may support driving. For example, a lane departure warning system (LDWS), to assist driving, may identify whether a vehicle is out of a driving lane and an adaptive cruise control (ACC) may automatically control the speed of the vehicle by maintaining a certain distance between the vehicle and a vehicle in front of the vehicle. In addition, an advanced driver assistance system (ADAS) and/or an autonomous driving system (ADS) including the technology described above may enable the vehicle to recognize and determine several situations while driving by using a detection sensor, an image processor, a communication device, and the like, and may control an operation of the vehicle or notify a driver of the vehicle of the situations. For example, the ADAS may provide the driver with driving information by recognizing lane lines of a driving road by using an image obtained from a camera and/or map information that has been established in advance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method with lane line determination includes: determining, from an input image, road feature information comprising a surrounding object and a road surface marking comprising a lane line; matching the road feature information to lane lines of a driving road on which a vehicle is driving; detecting whether there is a change in a road structure based on a result of the matching, wherein the change in the road structure comprises any one or any combination of any two or more of a change of the lane line, a loss of the lane line, and a change of a road sign; and based on whether the change in the road structure is detected, determining lane line information of the driving road by using information on the surrounding object.

The determining the road feature information may include any one or any combination of any two or more of: extracting features of a road surface comprising the road surface marking; determining a probability value of each type of the features of the road surface; and determining either one or both of a position and a speed of the surrounding object comprising a surrounding vehicle that is driving on the driving road.

The matching may include: determining a lane template corresponding to the driving road; determining a matching score by matching the lane template to the road feature information; and determining a number of candidate lane lines comprised in the driving road and spacing information between the candidate lane lines, based on the matching score.

The determining the lane template may include either one or both of: determining the lane template based on a curvature range of the candidate lane lines comprised in the driving road; and determining the lane template based on map information corresponding to the driving road.

The determining the matching score may include: sweeping the lane template into pixels of the candidate lane lines by moving and rotating the lane template; and determining a matching score of the candidate lane lines based on a number of pixels of the candidate lane lines matching the lane template through the sweeping.

The detecting whether there is the change in the road structure may include: detecting whether there is the change in the road structure by using any one or any combination of any two or more of a number of candidate lane lines comprised in the driving road based on the result of the matching, spacing information between the candidate lane lines, and information on the surrounding object.

The detecting whether there is the change in the road structure may include: determining a first number of lane lines comprised in the driving road from either one or both of navigation information of the vehicle and map information corresponding to the driving road; determining a second number of candidate lane lines of which a matching score is higher than a reference value among the candidate lane lines; and detecting whether there is the change in the road structure based on whether there is a difference between the first number of lane lines and the second number of candidate lane lines.

The detecting whether there is the change in the road structure may include: determining the spacing information between the candidate lane lines by using either one or both of map information corresponding to the driving road and width information of a driving lane in which the vehicle is driving; and detecting whether there is the change in the road structure based on a number of pairs of valid lane lines based on the spacing information.

The detecting whether there is the change in the road structure may include: assigning a penalty value of the candidate lane lines by using the information on the surrounding object comprising a surrounding vehicle, wherein the penalty value corresponds to candidate lane lines among the candidate lane lines in an area in which the surrounding vehicle is positioned; and based on the penalty value, detecting whether there is the change in the road structure comprising candidate lane lines corresponding to the area in which the surrounding vehicle is positioned.

The assigning the penalty value may include assigning a penalty value of candidate lane lines of a lane in which the surrounding vehicle is driving, among the candidate lane lines, based on whether a distance between the surrounding vehicle and right and left lane lines among the candidate lane lines of the surrounding vehicle based on a position and width of the surrounding vehicle is within a threshold value.

The determining the lane line information may include determining the lane line information by using the road feature information and a matching score of candidate lane lines recognized through the matching in response to the change in the road structure not being detected.

The determining the lane line information may include determining the lane line information by using a penalty value assigned by using the road feature information, candidate lane lines recognized through the matching, and the information on the surrounding object in response to the change in the road structure being detected.

The determining the lane line information in response to the change in the road structure being detected may include: determining reliability of each of the candidate lane lines of the driving road based the penalty value; and determining, based on the reliability of each of the candidate lane lines, the lane line information of the driving road by fitting the candidate lane lines to lane lines of the driving road.

The determining the lane line information of the driving road by fitting the candidate lane lines to the lane lines of the driving road may include: determining a driving equation corresponding to the driving road based on the reliability of each candidate lane line; and determining the lane line information by tracking multiple lane lines of the driving road by each lane line by using the driving equation.

The method may include: recognizing a position of the vehicle by using sensors comprised in the vehicle; extracting map property information of the driving road based on a current position of the vehicle from map information by using positioning information determined through the position of the vehicle; detecting whether there is the change in the road structure in the map information by using the map property information; and modifying the map information by reflecting the change in the road structure when the change in the road structure is detected.

The method may include: recognizing the position of the vehicle by using sensors comprised in the vehicle and the lane line information tracked by each lane line; extracting map property information of the driving road based on a current position of the vehicle by using the positioning information determined through the position of the vehicle; and detecting whether there is the change in the road structure by further using the map property information.

In another general aspect, one or more embodiments include a non-transitory computer-readable storage medium storing instructions that, when executed by one or more processors, configure the one or more processors to perform any one of, any combination of, or all operations and methods described herein.

In another general aspect, an apparatus with lane line determination includes: a processor configured to: determine, from an input image, road feature information comprising a surrounding object and a road surface marking comprising a lane line; match the road feature information to lane lines of a driving road on which a vehicle is driving; detect whether there is a change in a road structure based on a result of the matching, wherein the change in the road structure may include at least one of a change of a lane line, a loss of the lane line, and a change of a road sign; and determine lane line information by using information on the surrounding object based on whether the change in the road structure is detected.

For the detecting whether there is the change in the road structure, the processor may be configured to detect whether there is the change in the road structure by using any one or any combination of any two or more of a number of candidate lane lines comprised in the driving road based on the result of the matching, spacing information between the candidate lane lines, and the information on the surrounding object.

For the determining the lane line information, the processor may be configured to perform either one or both of: determining the lane line information by using the road feature information and a matching score of candidate lane lines recognized through the matching in response to the change in the road structure not being detected; and determining reliability of each of the candidate lane lines of the driving road by using a penalty value assigned by using the road feature information, the candidate lane lines recognized through the matching, and the information on the surrounding object and determine, based on the reliability of each of the candidate lane lines, the lane line information of the driving road by fitting the candidate lane lines to lane lines of the driving road.

In another general aspect, a processor-implemented method with lane line determination includes: determining, from an input image comprising a driving road, road feature information comprising a surrounding object and one or more lane lines; determining a number of candidate lane lines comprised in the driving road by matching the road feature information to a lane template corresponding to the driving road; determining a validity of the number of candidate lane lines based on any one or any combination of any two or more of the number of candidate lane lines, spacing information between the candidate lane lines, and information on the surrounding object; and in response to the number of candidate lane lines being determined as invalid, determining lane line information of the driving road by using information on the surrounding object.

The determining of the validity of the number of candidate lane lines may include detecting whether there is a change in a road structure based on a result of the matching, wherein the change in the road structure may include any one or any combination of any two or more of a change of the lane line, a loss of the lane line, and a change of a road sign.

Other features and aspects will be apparent from the following detailed description, the drawings, and the claims.

### BRIEF DESCRIPTION OF THE DRAWINGS

FIG. 1 illustrates an example of performing a method of determining lane line information.

FIG. 2 illustrates an example of a method of determining lane line information.

FIG. 3 illustrates an example of a method of matching lane lines of a driving road to road feature information.

FIGS. 4, 5, and 6 each illustrate an example of a method of detecting whether a road structure is changed.

FIG. 7 illustrates an example of a method of determining lane line information.

FIG. 8 illustrates an example of a device for determining lane line information.

FIG. 9 illustrates an example of a device for determining lane line information.

FIG. 10 illustrates an example of an operation result of components of a device for determining lane line information.

FIG. 11 illustrates an example of a method of matching a driving road to road feature information.

FIG. 12 illustrates an example of a method of detecting whether a road structure is changed.

FIG. 13 illustrates an example of a method of calculating reliability of each candidate lane line of a driving road.

FIG. 14 illustrates an example of a map change detection system.

FIG. 15 illustrates an example of a positioning system of an autonomous vehicle.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. It will be further understood that terms, such as those defined in commonly used dictionaries, should be interpreted as having a meaning that is consistent with their meaning in the context of the relevant art and the disclosure of the present application, and will not be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

As used herein, the term “and/or” includes any one and any combination of any two or more of the associated listed items. The phrases “at least one of A, B, and C”, “at least one of A, B, or C’, and the like are intended to have disjunctive meanings, and these phrases “at least one of A, B, and C”, “at least one of A, B, or C’, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The examples to be described below may be used to mark a lane line in an augmented reality navigation system of a smart vehicle and the like and/or generate visual information for assisting the steering of an autonomous vehicle. In addition, the examples may be used to assist safe and comfortable driving by interpreting visual information through a device including an intelligent system, such as a head up display (HUD) that is installed in a vehicle for driving assistance and/or fully autonomous driving. The examples may be applied to autonomous vehicles, intelligent vehicles, smartphones, mobile devices, and/or the like. Hereinafter, the examples are described in detail with reference to the accompanying drawings. When describing the examples with reference to the accompanying drawings, like reference numerals refer to like elements and a repeated description related thereto is omitted.

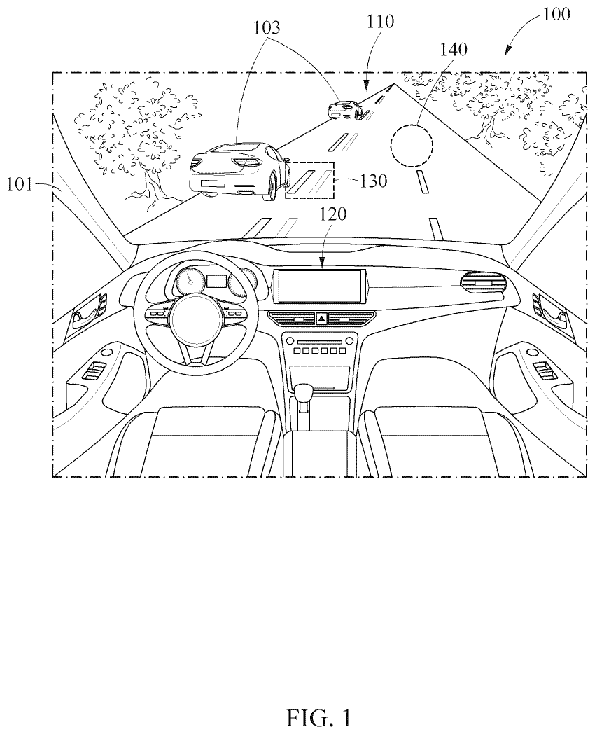

FIG. 1 illustrates an example of performing a method of determining lane line information. Referring to FIG. 1, surrounding vehicle(s) 103 driving on the same driving road 110 on which a vehicle 101 is driving is illustrated in a diagram 100.

For example, the vehicle 101 may be an intelligent vehicle including an advanced driver assistance system (ADAS) and/or an autonomous driving system (ADS), in which the intelligent vehicle recognizes and determines some situations while driving by using sensors, an image processor, a communication device, and the like, and controls an operation of the intelligent vehicle or notifies a driver of the intelligent vehicle of the situations. The ADAS may provide the vehicle 101 with recognized lane lines of the driving road 110 and relevant driving information by using an image obtained from a camera and/or map information that has been established in advance. In addition, the vehicle 101 may display various pieces of determined driving information, including the recognized lane lines, on the driving road 110 through a navigation 120 in the vehicle 101.

The surrounding vehicle(s) 103 may drive on the same driving road 110 on which the vehicle 101 drives and may refer to vehicles around the vehicle 101. The surrounding vehicle(s) 103 together with a temporary wall, a median strip, and the like that are on the driving road 110 may be collectively referred to as ‘surrounding objects’.

The ADAS and/or the ADS may recognize road surface markings including a lane line through a road image captured by the camera. For example, in a typical ADAS and/or the ADS, when a previous lane line (e.g., a lane line previously painted or drawn on the driving road 110) is detected together with a current lane line (e.g., a lane line newly painted or drawn on the driving road 110) as illustrated in diagram 130 despite a change of a lane line on the driving road 110, and/or when a lane line is lost and has disappeared as illustrated in a diagram 140, the previous lane line and the current lane line may be recognized together and a lane line may be inaccurately detected. The typical ADAS and/or the ADS may incorrectly set a driving lane because of the inaccurately detected lane line and thus may create a risk of an accident.

In contrast to the typical ADAS and/or the ADS, a device of one or more embodiments for determining lane line information (hereinafter, a ‘determination device’) may determine a driving lane based on information of a recognized surrounding vehicle and may improve the safety of vehicle control when the reliability of an object (e.g., a lane line and/or a road sign) detected from an input image decreases, as in the situations described above.

Hereinafter, a ‘vehicle’ may refer to all types of transportation that are used to transport a person or an item with a driving machine, such as an automobile, a bus, a motorcycle, and/or a truck. A ‘road’ may refer to a path where vehicles pass, which includes various types of roads, such as an expressway, a national highway, a local road, a national expressway, a driveway, and/or the like. The road may include one or more lanes. The ‘driving road’ 110 may be understood as a road on which the vehicle 101 is driving.

A ‘lane’ may refer to a road space divided by lane lines marked on a road surface. Hereinafter, a ‘driving lane’ may be understood as a lane in which a current vehicle is driving among a plurality of lanes, e.g., a lane space being occupied and used by the vehicle 101. The driving lane may be also referred to as an ‘ego lane’. A lane may be distinguished by lane lines left and/or right of the lane.

A ‘lane line’ may refer to a solid line or a dashed line marked on a road surface to divide lanes. The lane line may be expressed in various forms, such as a solid line or a dashed line in white, blue, and/or yellow colors on the road surface. Various types of lane lines included in a road surface marking may include various lane lines, such as a zigzag lane line, a bus-only lane line, a dividing line for pedestrians, and the like. A lane line for vehicles may be referred to as a ‘lane boundary line’ herein to distinguish the lane line for vehicles from other lane lines.

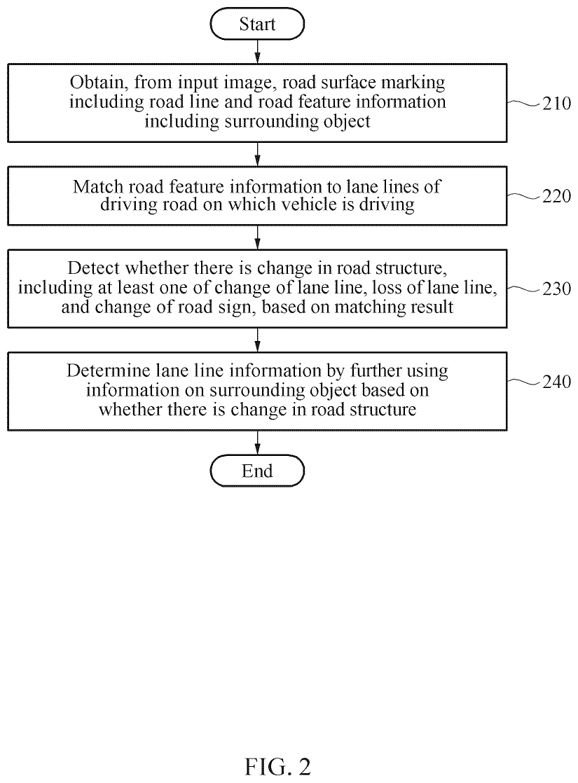

FIG. 2 illustrates an example of a method of determining lane line information. Operations 210 through 240 to be described hereinafter may be performed sequentially but not necessarily performed sequentially. For example, the order of the operations 210 through 240 may change and two or more of the operations 210 through 240 may be performed in parallel or simultaneously. Further, one or more of operations 210 through 240 may be omitted, without departing from the spirit and scope of the shown example. In addition to the description of FIG. 2 below, the description of FIG. 1 is also applicable to FIG. 2 and is incorporated herein by reference.

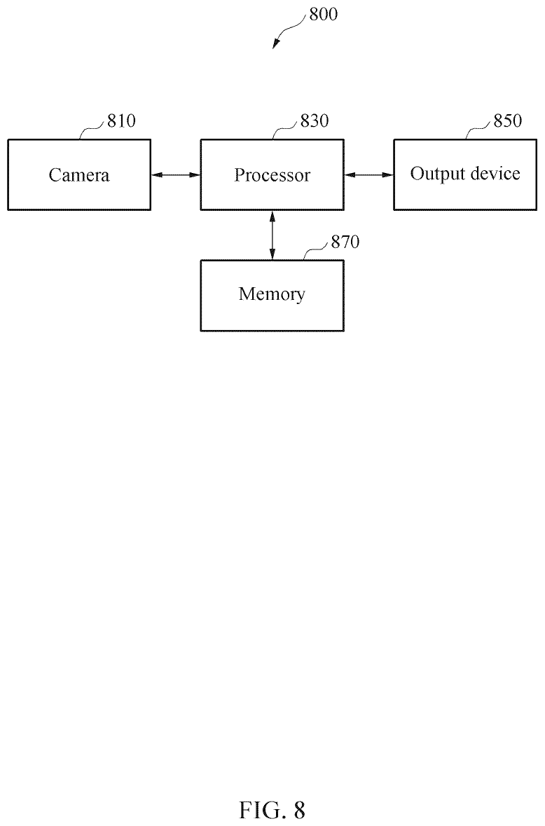

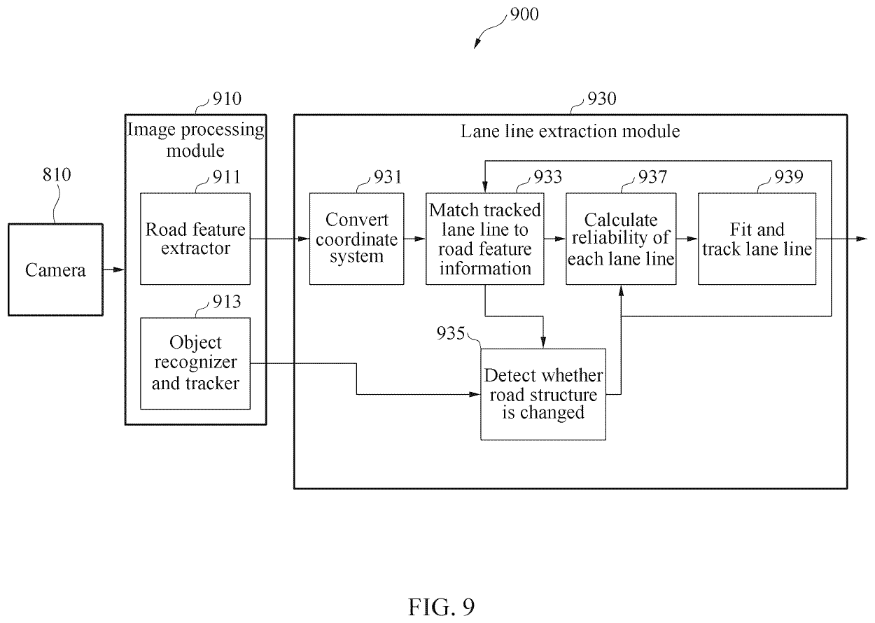

A determination device (e.g., a determination device 800 of FIG. 8 and/or a determination device 900 of FIG. 9) to be described herein may perform the method of determining lane line information. For example, the determination device may be implemented by a hardware module, e.g., a hardware module implementing software.

Referring to FIG. 2, the determination device may determine lane line information of a driving road through operations 210 to 240.

In operation 210, the determination device may obtain (e.g., determine), from an input image, a road surface marking including a lane line and road feature information including a surrounding object.

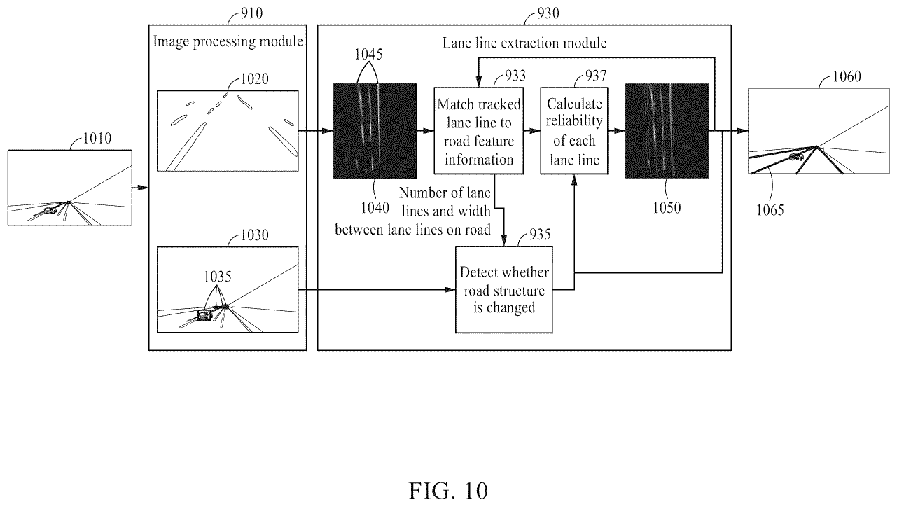

For example, the input image may include a road image and/or a road surface image including a vehicle, a lane line, a curb, a sidewalk, a surrounding environment, and/or the like as in an input image 1010 illustrated in FIG. 10. The determination device may obtain one or more input images by each frame by using a capturing device on the front of a vehicle. In an example, calibration information of the capturing device may be assumed to be known. For example, the capturing device may include a mono camera, a vision sensor, an image sensor, and/or a device for performing a similar function thereto. In addition, the input image may be an image captured by the capturing device included in the determination device or other devices. The input image may include a road boundary of the whole road or at least one of the left and right sides of the road.

A ‘road surface marking’ may refer to a marking on a road surface on which the vehicle is driving. The road surface marking may include a lane line and/or a road sign. The lane line may include a solid line, a double line, a dashed line, a centerline, a zigzag line, a bus-only line, a dividing line for pedestrians, and/or the like, in which the solid line indicates overtaking is prohibited, the dashed line indicates overtaking is allowed, the centerline includes the solid line indicating a lane change is prohibited and the dashed line indicating a lane change is allowed, and the zigzag line indicates slow driving. The road sign may indicate a direction, a signpost, a warning sign, and/or the like by using a symbol, such as an ascending slope sign, a crosswalk notice sign, a slow driving sign, a no-standing sign, and/or the like, and/or text, such as a ‘child protection zone’, ‘go slow’, and/or the like. In addition, the road surface marking may include an arrow and text and a word indicating for which bound a lane is, in which the arrow indicates go straight, turn right, turn left, go straight and turn right, go straight and turn left, turn left or right, make a U-turn, and/or the like and the text includes ‘go slow’, ‘speed limit’, ‘stop’, ‘child protection zone’, ‘unprotected left turn’, ‘yield’, and/or the like.

A ‘surrounding object’ may be understood as including structures, such as the surrounding vehicle(s) 103 that are around the vehicle 101 and driving on the same driving road on which the vehicle 101 is driving in FIG. 1, a temporary wall on a driving road, a median strip, and/or the like.

The determination device may extract road feature information including road surface markings from an input image by using a convolution neural network (CNN), a deep neural network (DNN), a support vector machine, and/or the like that have been trained in advance to recognize the road surface markings including lane lines. The CNN may be a region-based CNN, which has learned various road surface markings in a road surface image in advance. For example, the CNN may be trained to identify a lane line to be detected in an input image and a bounding box of a road sign and the type of the lane line to be detected and the type of the road sign. The determination device may extract road feature information including road surface markings and surrounding objects by using various machine learning methods. The determination device may calculate a probability value by each type (e.g., a class) of the road feature information. Alternatively or additionally, the determination device may calculate at least one of the position and speed of a surrounding object including a surrounding vehicle driving on the driving road as the road feature information. For example, the road feature information may be information representing the feature of a road, such as a road surface and road surface markings including a lane line and a road sign on the road surface, and may have a form of a segmentation image, a feature map, and/or a feature vector. A non-limiting example method of obtaining the road feature information by the determination device is described in detail below with reference to FIGS. 9 and 10.

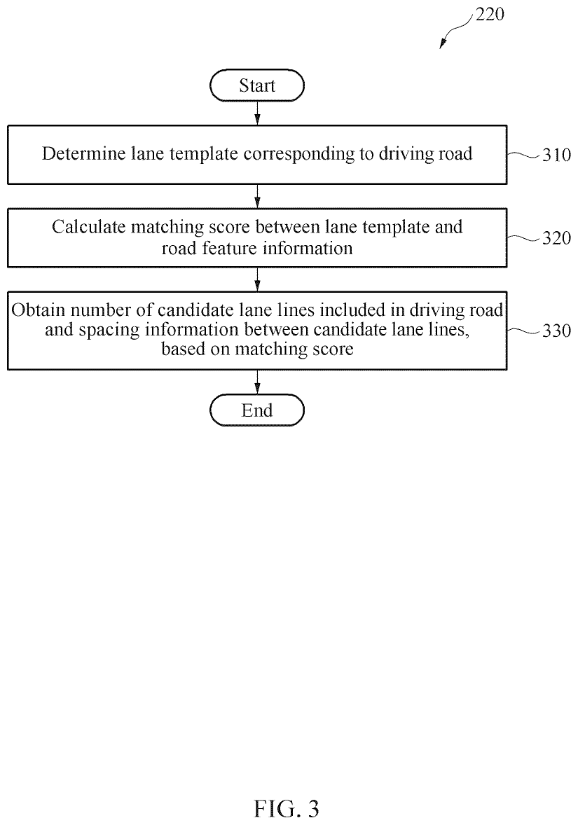

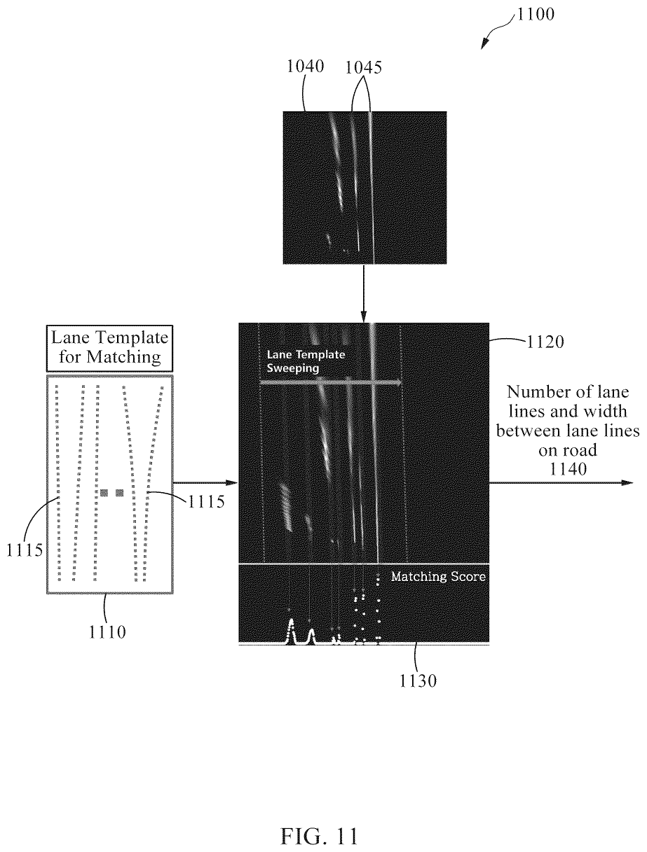

In operation 220, the determination device may match the road feature information obtained in operation 210 to lane lines of the driving road on which the vehicle is driving. A non-limiting example method of matching the road feature information to the lane lines of the driving road by the determination device is described in detail below with reference to FIGS. 3 and 11.

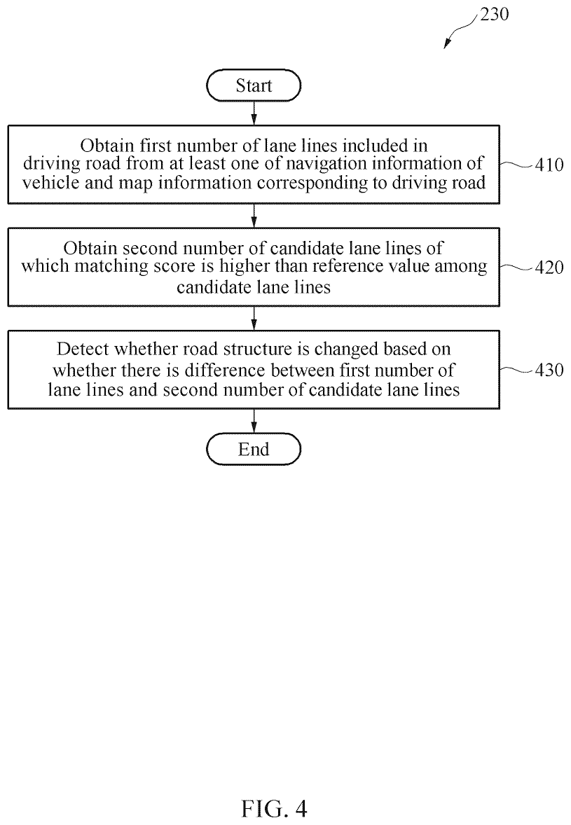

In operation 230, the determination device may detect whether there is a change in a road structure, including at least one of a change of a lane line, the loss of a lane line, and/or a change of a road sign, based on a result of the matching of operation 220. For example, the determination device may detect whether there is a change in the road structure by using any one or any combination of any two or more of a number (e.g., a total number or a total quantity) of candidate lane lines included in the driving road based on the result of the matching, spacing information between the candidate lane lines, and information on a surrounding object. The ‘candidate lane line(s)’ may be a candidate of lane lines that may be determined to be an actual lane line of the driving road through the matching method in operation 220. A non-limiting example method of detecting whether there is a change in the road structure by the determination device is described in detail below with reference to FIGS. 4 through 6 and 12.

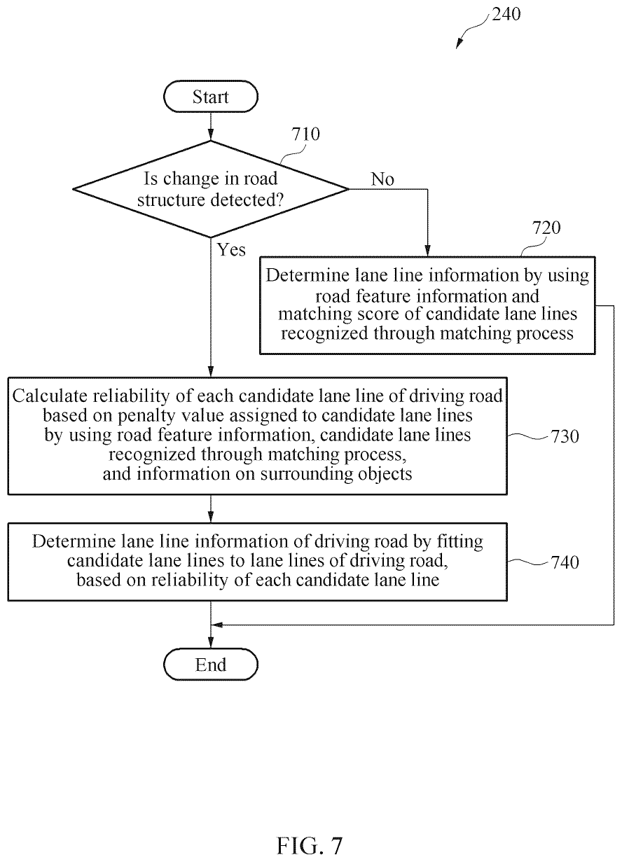

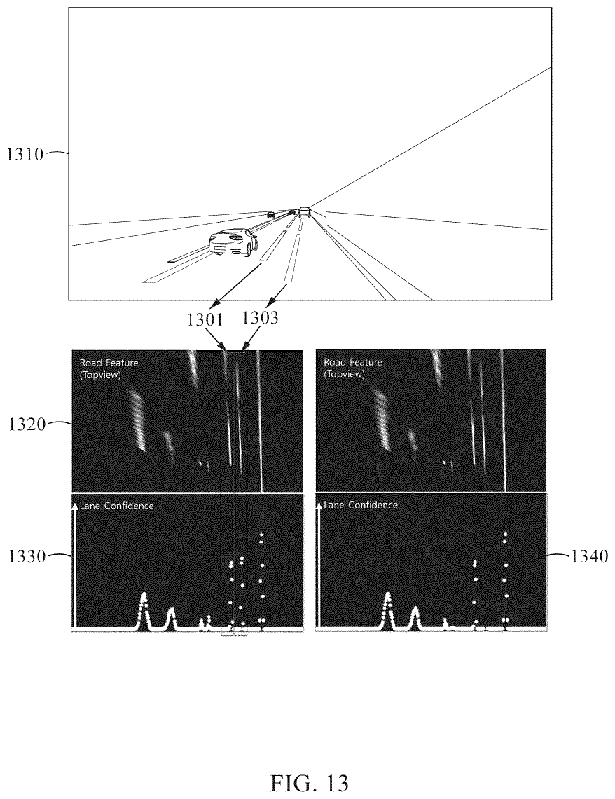

In operation 240, the determination device may determine lane line information of the driving road by further using information on the surrounding object based on whether there is a change in the road structure detected in operation 230. For example, when a change in the road structure is not detected, the determination device may determine the lane line information by using the road feature information and a matching score of the candidate lane lines recognized through the matching method. On the other hand, when a change in the road structure is detected, the determination device may determine the lane line information by further using the road feature information and the information on the surrounding object including a surrounding vehicle other than the candidate lane lines recognized through the matching method. A non-limiting example method of determining the lane line information of the driving road by the determination device is described in detail below with reference to FIGS. 7 and 13.

FIG. 3 illustrates an example of a method of matching lane lines of a driving road to road feature information. Operations 310 through 330 to be described hereinafter may be performed sequentially but not necessarily performed sequentially. For example, the order of the operations 310 through 330 may change and two or more of the operations 310 through 330 may be performed in parallel or simultaneously. Further, one or more of operations 310 through 330 may be omitted, without departing from the spirit and scope of the shown example. In addition to the description of FIG. 3 below, the descriptions of FIGS. 1 through 2 are also applicable to FIG. 3 and are incorporated herein by reference.

Referring to FIG. 3, a determination device may match candidate lane lines included in a driving road to road feature information obtained from an input image through operations 310 to 330.

In operation 310, the determination device may determine a lane template corresponding to the driving road. For example, the lane template may be a lane template 1110 illustrated in FIG. 11, but examples are not limited thereto. The determination device may determine a lane template based on the curvature ranges and/or curvature forms of the candidate lane lines included in the driving road. The determination device may determine, to be a lane template to be used in a matching method, a lane template having a curvature within a maximum curvature range value of lane lines on a road or lane line information tracked corresponding to a previous frame of the input image. Alternatively, the determination device may determine a lane template based on lane information extracted from map information corresponding to the driving road. The lane template corresponding to the lane information extracted from the map information corresponding to the driving road may be stored in advance in a database and the like.

In operation 320, the determination device may calculate (e.g., determine) a matching score by matching the lane template determined in operation 310 to the road feature information obtained in operation 210. The determination device may sweep the lane template, by moving and/or rotating the lane template, into the pixels of candidate lane lines (e.g., candidate lane lines 1045 of FIGS. 10 and 11) recognized by using the road feature information. The determination device may calculate the matching score of the candidate lane lines based on a number (e.g., a total number or a total quantity) of pixels of the candidate lane lines matching the lane template through the sweeping. The determination device may extract the lane line information of a lane line area of which a matching score with the pixels including the feature information of the candidate lane lines is the highest by moving and/or rotating the lane template in a certain direction.

In operation 330, the determination device may obtain the number of candidate lane lines included in the driving road and spacing information between the candidate lane lines, based on the matching score calculated in operation 320.

FIG. 4 illustrates an example of a method of detecting whether a road structure is changed. Operations 410 through 430 to be described hereinafter may be performed sequentially but not necessarily performed sequentially. For example, the order of the operations 410 through 430 may change and two or more of the operations may be performed in parallel or simultaneously. Further, one or more of operations 410 through 430 may be omitted, without departing from the spirit and scope of the shown example. In addition to the description of FIG. 4 below, the descriptions of FIGS. 1 through 3 are also applicable to FIG. 4 and are incorporated herein by reference.

Referring to FIG. 4, a determination device may detect whether the road structure is changed based on the number of lanes included in a driving road through operations 410 to 430.

In operation 410, the determination device may obtain a first number (e.g., a total number or a total quantity) of lanes included in the driving road from at least one of navigation information of a vehicle and map information corresponding to the driving road.

In operation 420, the determination device may obtain a second number (e.g., a total number or a total quantity) of candidate lane lines of which a matching score is higher than a reference value among the candidate lane lines recognized through the matching method described above with reference to FIG. 3.

In operation 430, the determination device may detect whether the road structure is changed based on whether there is a difference between the first number of lane lines obtained in operation 410 and the second number of candidate lane lines obtained in operation 420. For example, when there is a difference between the first number of lane lines obtained from the navigation information and/or the map information and the second number of lane lines in an area of which a matching score is higher than a reference value, the determination device may determine that there is a change in the road structure in the driving road. The determination device may detect an area in which there is a difference between the first number and the second number as an area where a lane line is changed. When there is no difference between the first number of lane lines obtained from the navigation information and/or the map information and the second number of lane lines in an area of which the matching score is higher than the reference value, the determination device may determine that there is no change in the road structure in the driving road.

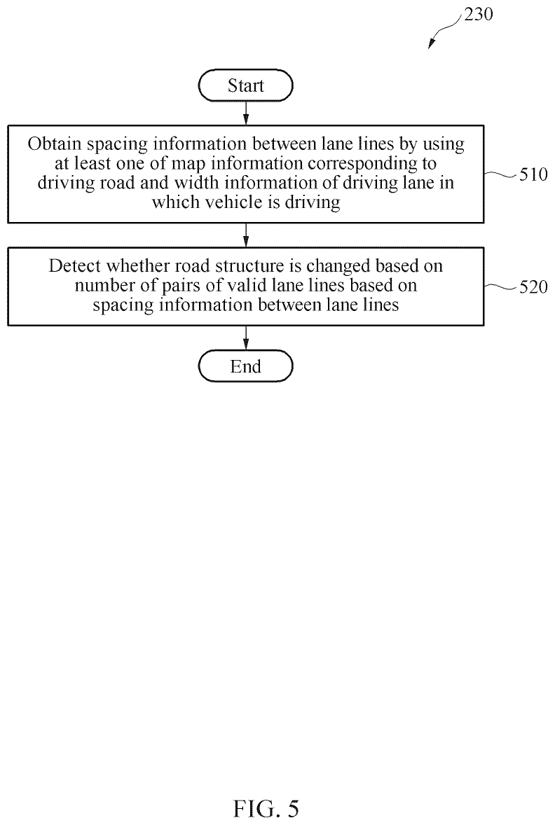

FIG. 5 illustrates an example of a method of detecting whether a road structure is changed. Operations 510 through 520 to be described hereinafter may be performed sequentially but not necessarily performed sequentially. For example, the order of the operations 510 through 520 may change and two or more of the operations may be performed in parallel or simultaneously. Further, one or more of operations 510 through 520 may be omitted, without departing from the spirit and scope of the shown example. In addition to the description of FIG. 5 below, the descriptions of FIGS. 1 through 4 are also applicable to FIG. 5 and are incorporated herein by reference.

Referring to FIG. 5, a determination device may detect whether the road structure is changed based on spacing information between lane lines through operations 510 and 520.

In operation 510, the determination device may obtain the spacing information between lane lines by using at least one of map information corresponding to a driving road that is being tracked and width information of a driving lane in which a vehicle is driving. In an example, the map information may be a high definition (HD) map, which is a three-dimensional (3D) map having centimeter (cm)-level precision for autonomous driving, but examples are not limited thereto.

In operation 520, the determination device may detect whether the road structure is changed based on a number (e.g., a total number or a total quantity) of pairs of valid lane lines based on the spacing information between lane lines obtained in operation 510. For example, when there are pairs of valid lane lines, the spacing information between lane lines may be used to determine whether the road structure is changed. In an example, a ‘pair of valid lane line(s)’ may be a pair of lane lines having a width greater than or equal to a lane space that is sufficient for the vehicle to drive.

For example, when the number of candidate lane lines in an area of which a matching score is higher than a reference value is not the same as the number of valid lane lines, the determination device may determine that the road structure is changed.

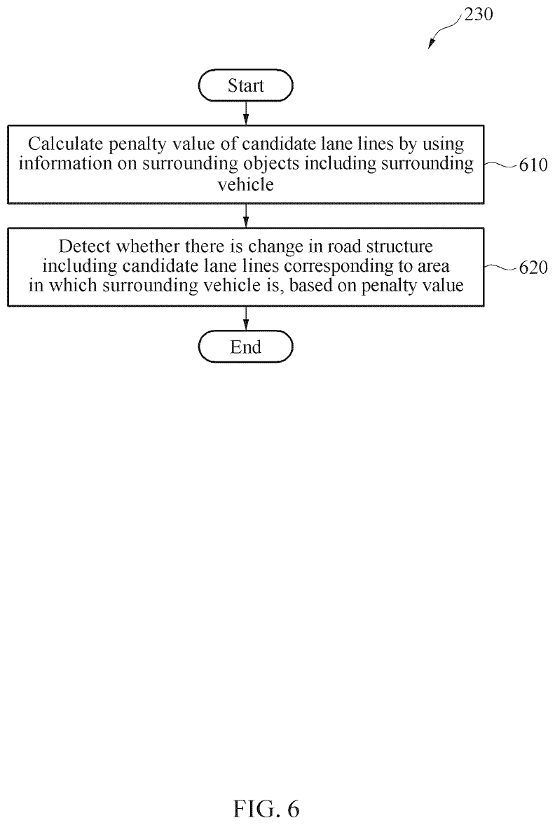

FIG. 6 illustrates an example of a method of detecting whether a road structure is changed. Operations 610 through 620 to be described hereinafter may be performed sequentially but not necessarily performed sequentially. For example, the order of the operations 610 through 620 may change and two or more of the operations may be performed in parallel or simultaneously. Further, one or more of operations 610 through 620 may be omitted, without departing from the spirit and scope of the shown example. In addition to the description of FIG. 6 below, the descriptions of FIGS. 1 through 5 are also applicable to FIG. 6 and are incorporated herein by reference.

Referring to FIG. 6, a determination device may detect whether the road structure is changed based on information on a surrounding vehicle through operations 610 and 620.

In operation 610, the determination device may assign a penalty value to candidate lane lines based on information on surrounding objects including the surrounding vehicle. In an example, the information on surrounding objects may be obtained through image information of the front, rear, left, and right of a vehicle that is captured by a capturing device, but examples are not limited thereto. The information on surrounding objects may include the position and width of the surrounding objects including the surrounding vehicle, but examples are not limited thereto. The penalty value may correspond to a candidate lane line in an area in which the surrounding vehicle is positioned. For example, the determination device may assign the penalty value to candidate lane lines corresponding to a lane line area over which the surrounding vehicle drives by using position and width information of the surrounding vehicle, in which the matching scores of the candidate lane lines are calculated through operation 320 of FIG. 3.

When assigning the penalty value thereto in operation 610, the determination device may determine whether the surrounding vehicle of which the position is a base position is a vehicle that is normally driving along the centerline of the left and right lane lines of the vehicle. When the surrounding vehicle is a normally driving vehicle, the determination device may assign the penalty value to the candidate lane lines based on the position of the surrounding vehicle. The penalty value may be ‘0’ or ‘0.1’, but examples are not limited thereto.

The determination device may determine whether the surrounding vehicle is normally driving based on whether a distance between the surrounding vehicle and the left and right lane lines of the surrounding vehicle is within a threshold value based on the position and width of the surrounding vehicle.

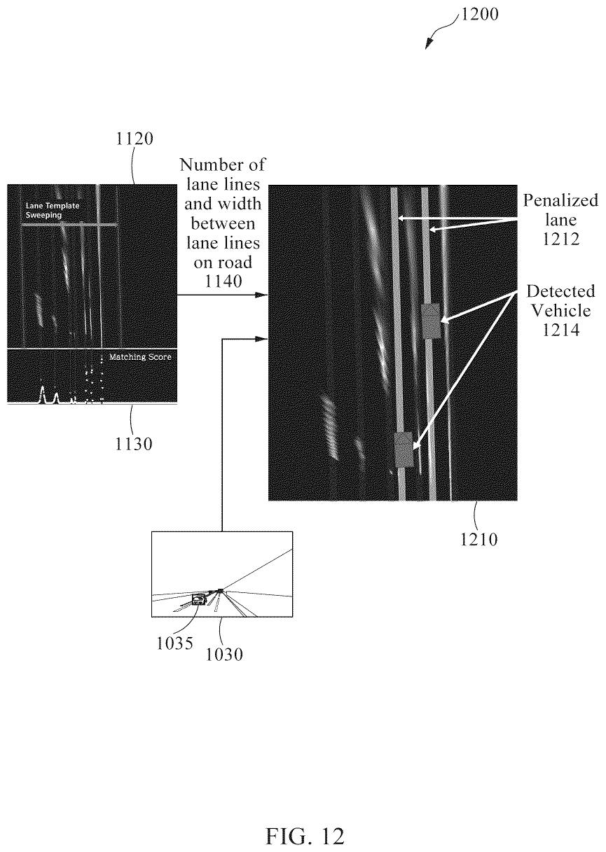

In operation 620, the determination device may detect whether there is a change in a road structure, based on the penalty value assigned in operation 610, including the candidate lane lines corresponding to an area in which the surrounding vehicle is. For example, the determination device may determine the candidate lane lines corresponding to the area in which the surrounding vehicle is, based on a matching score to which the penalty value is assigned, to be an area in which the road structure is changed. A non-limiting example method of detecting whether the road structure is changed based on the information on the surrounding vehicle by the determination device is described in detail below with reference to FIG. 12.

FIG. 7 illustrates an example of a method of determining lane line information. Operations 710 through 740 to be described hereinafter may be performed sequentially but not necessarily performed sequentially. For example, the order of the operations 710 through 740 may change and two or more of the operations may be performed in parallel or simultaneously. Further, one or more of operations 710 through 740 may be omitted, without departing from the spirit and scope of the shown example. In addition to the description of FIG. 7 below, the descriptions of FIGS. 1 through 6 are also applicable to FIG. 7 and are incorporated herein by reference.

Referring to FIG. 7, a determination device may determine the lane line information of a driving road by further using information on surrounding objects based on whether a change in a road structure is detected through operations 710 to 740.

In operation 710, the determination device may determine whether a change in the road structure is detected. When a change in the road structure is not detected in operation 710, the determination device may, in operation 720, determine the lane line information by using road feature information and a matching score of candidate lane lines recognized through a matching method. For example, the determination device may determine multiple lane lines of the driving road by fitting candidate lane lines of which the matching score is higher than a certain reference value to the input image.

When a change in the road structure is detected in operation 710, the determination device may, in operation 730, calculate the reliability of each candidate lane line of the driving road based on a penalty value assigned by using the road feature information, the candidate lane lines recognized through the matching method, and the information on surrounding objects including a surrounding vehicle. A non-limiting example method of calculating the reliability of each candidate lane line of the driving road by the determination device is described in detail below with reference to FIG. 13.

In operation 740, the determination device may determine the lane line information of the driving road by fitting the candidate lane lines to lane lines on the driving road that are displayed in the input image, based on the reliability of each candidate lane line that is calculated in operation 730. The determination device may calculate a driving equation corresponding to the driving road, based on the reliability of each candidate lane line. The determination device may determine the lane line information by tracking the multiple lane lines on the driving road by each lane line by using the driving equation. In an example, the tracking by each lane line may be performed on the position of the lane line, the form of the lane line, the width of a road, a centerline between the lane lines, and/or the like.

FIG. 8 illustrates an example of a device for determining lane line information. Referring to FIG. 8, a determination device 800 may include a camera 810 (e.g., one or more cameras), a processor 830 (e.g., one or more processors), and an output device 850. The determination device 800 may further include a memory 870 (e.g., one or more memories).

The camera 810 may capture an input image. For example, the camera 810 may include a mono camera, a vision sensor, an image sensor, or a device for performing a similar function thereto. There may be one or more cameras 810.

The processor 830 may obtain, from the input image, road feature information including a lane line marking, a road surface marking, and a surrounding object. The processor 830 may match lane lines of a driving road on which a vehicle is driving to the road feature information. The processor 830 may detect whether there is a change in a road structure, including at least one of a change of a lane line and a loss of a lane line, based on a result of the matching. The processor 830 may detect whether the road structure is changed by using any one or any combination of any two or more of the number of candidate lane lines, based on the result of the matching, included in the driving road, spacing information between the candidate lane lines, and information on the surrounding object.

The processor 830 may determine the lane line information by further using the information on the surrounding object, based on whether the road structure is changed. For example, when a change in the road structure is not detected, the processor 830 may determine the lane line information by using the road feature information and a matching score of the candidate lane lines recognized through a matching method. On the other hand, when a change in the road structure is detected, the processor 830 may calculate the reliability of each candidate lane line of the driving road by using a penalty value assigned by using the road feature information, the candidate lane lines recognized through the matching method, and the information on the surrounding object including a surrounding vehicle. The processor 830 may determine the lane line information of the driving road by fitting the candidate lane lines to lane lines on the driving road that are displayed in the input image, based on the reliability of each candidate lane line.

The output device 850 may output the lane line information determined by the processor 830. For example, the output device 850 may be an output interface or a display device. When the output device 850 is a display, the output device 850 may display, in the input image or a navigation image, the lane line information, which is determined by the processor 830, of the driving road. In addition, when a driving lane or lane line needs to be changed according to a prediction based on the lane line information determined by the processor 830, the output device 850 may display a direction to which the driving lane is changed.

For example, the memory 870 may store an input image, a segmentation image, the number of lanes on a road, a space between the lanes, map information and/or navigation information. The memory 870 may store an input image that is converted into a planar viewpoint by the processor 830 and a segmentation image that is converted into a planar viewpoint by the processor 830.

In addition, the memory 870 may store parameters of a neural network that is pretrained to recognize a road surface marking including a lane line and a road sign. The processor 830 may detect the road surface marking in the input image by using the neural network to which the parameters, which is stored in the memory 870, of the neural network are applied. For example, the neural network may be a CNN. The CNN may be trained to identify both a bounding box of a lane line (or a road sign) to be detected in the input image and the type of the lane line (or the road sign) to be detected in the input image.

In addition, the memory 870 may store various pieces of information generated by the processing of the processor 830. The memory 870 may also store various pieces of data, programs, and the like. The memory 870 may include a volatile memory or a non-volatile memory. The memory 870 may include a massive storage medium, such as a hard disk, and store the various pieces of data.

In addition, the processor 830 may perform the methods described with reference to FIGS. 1 to 15 and an algorithm corresponding to the methods. The processor 830 may execute a program and control the determination device 800. The code of the program executed by the processor 830 may be stored in the memory 870. The memory 870 may store instructions that, when executed by the processor 830, configure the processor 830 to perform any one of, any combination of any two or more of, or all operations and methods described herein with respect to FIGS. 1 through 15.

FIG. 9 illustrates an example of a determination device and FIG. 10 illustrates an example of an operation result of components of a determination device.

Referring to FIGS. 9 and 10, a determination device 900 may include a camera 810, an image processing module 910, and a lane line extraction module 930. Operations of the image processing module 910 and/or the lane line extraction module 930 may be performed by the processor 830 of the determination device 800 described above with reference to FIG. 8, but examples are not limited thereto.

The determination device 900, to determine lane line information, may perform image processing, through the image processing module 910, on an input image 1010 that is obtained by the camera 810 and may extract the lane line information through the lane line extraction module 930. In an example, the image processing may be a process of extracting a road feature from the input image 1010 and a process of extracting object information from the input image 1010.

The image processing module 910 may include a road feature extractor 911 and an object recognizer and tracker 913.

The road feature extractor 911 may extract the road feature and/or road feature information, in which the road feature includes a lane line, a road surface marking, and/or a road surface and the road feature information includes a probability value of each type of the road feature.

For example, the road feature extractor 911 may extract the road feature information as in a segmentation image 1020 illustrated in FIG. 10. The segmentation image 1020 may be an image of segmenting, by semantic units, objects (e.g., a road, a lane line, a lane boundary line, etc.) included in the input image 1010. The determination device 900 may generate the segmentation image 1020 by segmenting, by semantic units, an object from the input image 1010, identifying, by pixels, the meaning of a segmented area, and labelling the segmented area by each class. For example, there may be 20 classes according to the semantic units, such as a road, a vehicle, a sidewalk, a person, an animal, the sky, a building, and/or the like. The determination device 900 may precisely identify where and how components, such as an object, a background, and the like, are in an image through labels in a pixel unit that are included in the segmentation image 1020. In addition, the determination device 900 may classify the components included in the segmentation image 1020 by using a pretrained CNN, a DNN, a support vector machine, and the like. The determination device 900 may generate the segmentation image 1020 through a classification network including a multi-stage convolutional layer and a fully connected layer. The determination device 900 may generate the segmentation image 1020 by segmenting, by semantic units, an object from the input image 1010 by using a well-known classification network, such as AlexNet, VGGNet, and GoogleNET, identifying, by pixels, the meaning of a segmented area, and labelling the segmented area by each class.

The road feature information (e.g., the segmentation image 1020) extracted by the road feature extractor 911 may be used in operation 931, performed by the lane line extraction module 930, of converting a coordinate system, e.g., converting an image coordinate system into a world coordinate system.

The object recognizer and tracker 913 may perform object recognition and object tracking to calculate the position and speed of a certain object, such as a vehicle and/or a two-wheeler, in an image. The object recognizer and tracker 913 may recognize and/or track an object through a bounding box 1035 illustrated in a diagram 1030. The information on the recognized and/or tracked object by the object recognizer and tracker 913 may be used in operation 935, performed by the lane line extraction module 930, of detecting whether a road structure is changed.

The lane line extraction module 930 may perform operation 931 of converting a coordinate system, operation 933 of matching a tracked lane line to the road feature information, operation 935 of detecting whether a road structure is changed, operation 937 of calculating the reliability of each lane line, and operation 939 of fitting and tracking a lane line.

In operation 931, to extract lane line information, the lane line extraction module 930 may first convert the road feature information and pieces of object information in an image coordinate system into a world coordinate system. The lane line extraction module 930 may convert the input image 1010 and/or the segmentation image 1020 expressed in an image coordinate system into a planar viewpoint image 1040 expressed in a world coordinate system in operation 931 of converting a coordinate system. For example, the determination device 900 may convert the input image 1010 and/or the segmentation image 1020 into the planar viewpoint image 1040 by applying an inverse perspective mapping (IPM) technique to a lane line detected in the input image 1010 and/or the segmentation image 1020. The IPM technique may be a technique of removing a perspective effect from the input image 1010 and/or the segmentation image 1020 having a perspective effect and converting position information on an image plane into position information in a world coordinate system. Through IPM, from position information of a candidate lane line 1045 expressed in a world coordinate system, the lane line extraction module 930 may easily express a normal distance from the centerline of a road to the center point of a vehicle and a relative position of the vehicle to a driving road defined in a moving direction of the vehicle.

Alternatively or additionally, when calibration information (e.g., the height of the position of a camera, the angle of the camera towards the ground, the angle of the camera towards the front, and a projection matrix of the camera) of the camera 810 is already determined, the lane line extraction module 930 may obtain the planar viewpoint image 1040 through homograph mapping. For example, when the calibration information of the camera 810 has not been obtained in advance, the lane line extraction module 930 may find points on two parallel lines in the input image 1010 and obtain approximate calibration information by converting an actual distance and pixel distance of the points. The lane line extraction module 930 may obtain values (e.g., the actual distance between the points on the two parallel lines, etc.) because lane lines in a road environment are generally parallel and the width between the lane lines generally follows road standards.

In operation 933, the lane line extraction module 930 may match lane lines on a tracked driving road on which the vehicle is driving to the road feature information (e.g., the candidate lane lines 1045) included in the planar viewpoint image 1040. The lane line extraction module 930 may obtain the number of lane lines on the driving road and a space between the lane lines by matching lane lines on a previously tracked driving road to the candidate lane lines 1045 included in the planar viewpoint image 1040, for example, by using lane line information tracked in a previous frame of the input image 1010 and/or preset lane line curvature range information. A non-limiting example of operation 933 of matching tracked lane lines to the road feature information is described in detail below with reference to FIG. 11.

In operation 935, the lane line extraction module 930 may detect whether a road structure is changed by using any one or any combination of any two or more of the number of lane lines included in the driving road obtained in operation 933, spacing information between the lane lines, and information on a surrounding object.

The number of lane lines included in the driving road may be obtained, for example, through navigation information or a database of a map or through the number of lane lines tracked in operation 933. For example, when there is a difference between a first number of lane lines included in the driving road obtained from the navigation information of the vehicle and/or map information corresponding to the driving road and a second number of candidate lane lines of which a matching score is higher than a reference value among candidate lane lines identified from the road feature information in operation 933, the determination device 900 may, in operation 935, determine an area to be an area in which a road structure is changed, e.g., an area in which a road is newly drawn.

The spacing information between lane lines may be obtained, for example, by width information of the driving road tracked in the previous frame of the input image 1010 and/or the map information corresponding to the driving road. The spacing information between lane lines may be used to detect whether a road structure is changed when there are pairs of valid lane line information.

In addition, the information on a surrounding object may be obtained through the object recognizer and tracker 913 and may include tracking information of a surrounding vehicle.

A non-limiting example method of detecting whether a road structure is changed by the lane line extraction module 930 is described in detail below with reference to FIG. 12.

In operation 935, the lane line extraction module 930 may calculate the reliability of each candidate lane line on the driving road by using a penalty value calculated by using the road feature information extracted from the planar viewpoint image 1040 converted to a world coordinate system, the candidate lane lines 1045 recognized through a matching method in operation 933, and the information on a surrounding object, such as the diagram 1030. A non-limiting example method of calculating the reliability of each candidate lane line on the driving road by the lane line extraction module 930 is described in detail below with reference to FIG. 13.

In operation 939 of fitting and tracking a lane line, the determination device 900 may determine lane line information by fitting candidate lane lines, based on the reliability of each candidate lane line, to lane lines on the driving road that are displayed as lane lines 1065 in the input image 1010 as an output image 1060 and track the lane lines on the driving road according to the determined lane line information.

FIG. 11 illustrates an example of a method of matching a driving road to road feature information. Referring to FIG. 11, a process of matching the driving road to the road feature information is illustrated in a diagram 1100.

As described above, when a lane template 1110 is determined based on a curvature range of lane lines included in the driving road and/or map information corresponding to the driving road, the lane line extraction module 930 may move and rotate the lane template 1110 and sweep the lane template 1110 into pixels of candidate lane lines 1045 based on road feature information of a planar viewpoint image 1040. The lane line extraction module 930 may calculate a matching score based on a number (e.g., a total number or a total quantity) of pixels of the candidate lane lines 1045 matching lane lines 1115 of the lane template 1110 through the sweeping of a diagram 1120. The lane line extraction module 930 may calculate matching scores respectively corresponding to the candidate lane lines 1045 as in a diagram 1130. The lane line extraction module 930 may obtain the number of lane lines of which a matching score is greater than a certain threshold among the matching scores illustrated in the diagram 1130 and an interval (width) 1140 between the lane lines.

FIG. 12 illustrates an example of a method of detecting whether a road structure is changed. Referring to FIG. 12, a diagram 1200 is illustrated to describe the method of detecting whether a road structure is changed by using the number of and the interval 1140 between lane lines included in a road obtained through a matching method performed by the lane line extraction module 930 and information on a surrounding object recognized and tracked through a bounding box 1035 of a diagram 1030.

The lane line extraction module 930 may assign a penalty value to candidate lane lines of which a matching score is calculated as in a diagram 1130 by using the information on the surrounding object including a surrounding vehicle recognized and tracked through the bounding box 1035 of the diagram 1030. The penalty value may correspond to a candidate lane line in an area in which the surrounding vehicle is positioned.

The lane line extraction module 930 may determine, to be a penalized lane 1212, candidate lane lines corresponding to a lane line area over which surrounding detected vehicle(s) 1214 drive among candidate lane lines by using the position and width information of the detected vehicle(s) 1214 obtained through the diagram 1030.

In an example, the lane line extraction module 930 may determine the penalized lane 1212 by assigning a penalty value to lane lines of a lane in which the detected vehicle(s) 1214 is driving, according to whether a distance between the detected vehicle(s) 1214 and the left and right lane lines is within a threshold value based on the position and width of the detected vehicle(s) 1214. The lane line extraction module 930 may determine whether the detected vehicle(s) 1214 is a normally driving vehicle along the centerline of the left and right lane lines by determining that the distance of the detected vehicle(s) 1214 and the left and right lane lines is within the threshold value.

When assigning the penalty value thereto, the lane line extraction module 930 may determine whether the detected vehicle(s) 1214 of which the position is a base position is a vehicle that is normally driving along the centerline of the left and right lane lines of the vehicle. When the detected vehicle(s) 1214 is a normally driving vehicle, the lane line extraction module 930 may assign the penalty value to the candidate lane lines based on the position of the detected vehicle(s) 1214. The penalty value may be ‘0’ or ‘0.1’, but examples are not limited thereto. When the detected vehicle(s) 1214 that is driving normally is over a candidate lane line, the candidate lane line may be understood to be an erased lane line (e.g., an erroneous candidate lane line). Therefore, the lane line extraction module 930 may assign a penalty value (e.g., ‘0’) such that the candidate lane line may not be selected as a lane of a driving road and remove the candidate lane line.

Based on the penalty value, the lane line extraction module 930 may detect whether there is a change in a road structure including candidate lane lines corresponding to an area where the detected vehicle(s) 1214 is positioned. When the matching score to which the penalty value is assigned (e.g., the matching score multiplied by the penalty value) is less than a reference value, the candidate lane lines corresponding to an area where the detected vehicle(s) 1214 is positioned may be determined to be an area where a road structure is changed.

Based on the penalty value, the lane line extraction module 930 may determine that there is a road structure change in the candidate lane lines corresponding to the area where the detected vehicle(s) 1214 is positioned.

FIG. 13 illustrates an example of a method of calculating reliability of each candidate lane line of a driving road. FIG. 13 is a diagram illustrating the method of calculating the reliability of each candidate lane line of the driving road by using a penalty value by the lane line extraction module 930.

When a road structure change is detected as in an image 1310, the lane line extraction module 930 may calculate the reliability of each candidate lane line of the driving road as in a diagram 1330 by applying a penalty value to candidate lane lines 1301 and 1303 of which a matching score is calculated through a matching method, such as a diagram 1320. The reliability of each candidate lane line may be determined by applying a penalty value to a matching score of the candidate lane lines, but examples are not limited thereto. The reliability of each candidate lane line may use the matching score calculated as described above or a value obtained by applying a weight based on lane line information obtained from a previous frame of an input image to the matching score.

For example, the matching score of the candidate lane lines 1301 and 1303 may be assumed to be higher than a certain standard, but a penalty value (e.g., ‘0’) may be assumed to be assigned to the candidate lane line 1303 after the candidate lane line 1303 is identified to be driven over by a surrounding vehicle.

The lane line extraction module 930 may remove, from the diagram 1330, the candidate lane line 1303 of which the reliability is ‘0’ after assigning the penalty value ‘0’ to the candidate lane line 1303 and may determine the rest of candidate lane lines (e.g., including candidate lane line 1301) to be lane line information of the driving road as in a diagram 1340.

When a change of a lane line causes a road structure change as in the image 1310 and the lane line is fitted based on road feature information, accurate lane line information may be not readily output because of erased lane line information that is irrelevant to driving. In an example, when there is a road structure change, the determination device of one or more embodiments may increase the accuracy of controlling the driving of a vehicle by calculating the reliability of each lane line by reflecting a penalty value calculated by using information (e.g., driving information of the surrounding vehicle) on a surrounding object including the surrounding vehicle. The determination device of one or more embodiments may not rely on the erased lane line that is unnecessary for driving.

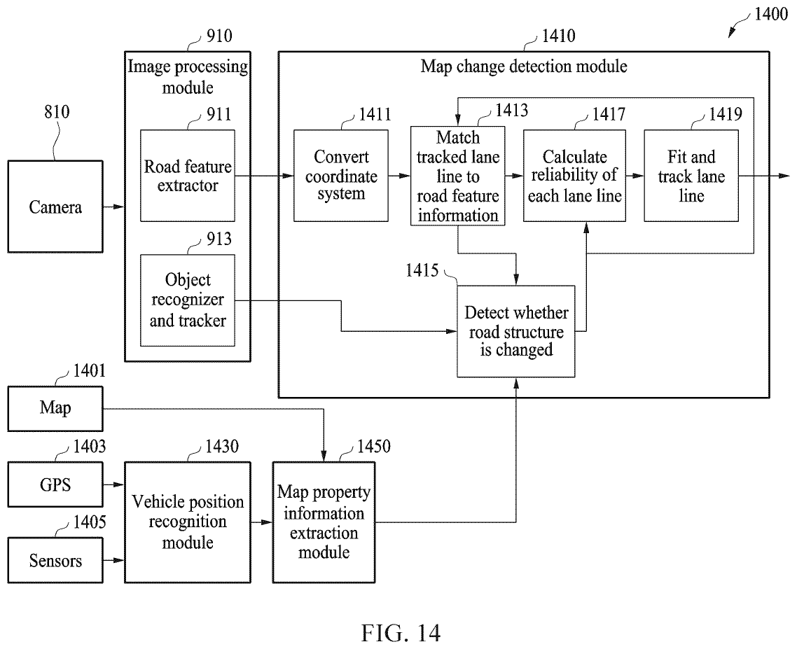

FIG. 14 illustrates an example of a map change detection system. Referring to FIG. 14, a map change detection system 1400 using the determination device 900 is illustrated. Hereinafter, a configuration and operation of the map change detection system 1400, which are different from those of the determination device 900, are mainly described.

The map change detection system 1400 may further include a map change detection module 1410 that may be or include the lane line extraction module 930, a vehicle position recognition module 1430, and a map property information extraction module 1450, besides a camera 810 and an image processing module 910 that are included in the determination device 900.

The map change detection module 1410 may detect a map information change by using lane line information determined by the lane line extraction module 930. Operation 1411 of converting a coordinate system, operation 1413 of matching a tracked lane line to road feature information, operation 1415 of detecting whether a road structure is changed, operation 1417 of calculating the reliability of each lane line, and operation 1419 of fitting and tracking a lane line that are performed in the map change detection module 1410 may, in an example, respectively be the same as operation 931 of converting a coordinate system, operation 933 of matching a tracked lane line to road feature information, operation 935 of detecting whether a road structure is changed, operation 937 of calculating the reliability of each lane line, and operation 939 of fitting and tracking a lane line that are performed by the lane line extraction module 930 of FIG. 9, and thus, the descriptions thereon are not repeated.

The vehicle position recognition module 1430 may recognize the position of a vehicle by using sensors (e.g., a global positioning system (GPS) sensor 1403 and other sensors 1405) included in the vehicle. The vehicle position recognition module 1430 may use an inertial measurement unit (IMU), an on-board diagnostics (OBD) sensor, and/or a visual driving distance measurement technique, besides the GPS sensor 1403, to increase the accuracy of recognizing the position of the vehicle. For example, the vehicle position recognition module 1430 may measure an absolute position of the vehicle through the GPS sensor 1403 and modify the absolute position of the vehicle by using the moving direction and speed of the vehicle that are measured through an OBD sensor. In addition, the vehicle position recognition module 1430 may measure the movement and direction of the vehicle by further using an acceleration sensor and a gyro sensor.

The map property information extraction module 1450 may extract map property information of surrounding roads based on the current position of the vehicle from map information 1401 by using positioning information calculated through the position of the vehicle recognized by the vehicle position recognition module 1430.

The map change detection module 1410 may detect whether a road structure is changed in the map information 1401 in operation 1417 of detecting whether a road structure is changed by using the map property information extracted by the map property information extraction module 1450. When a road structure change is detected in the map information 1401, the map change detection module 1410 may modify the map information 1401 by reflecting the changed road structure.

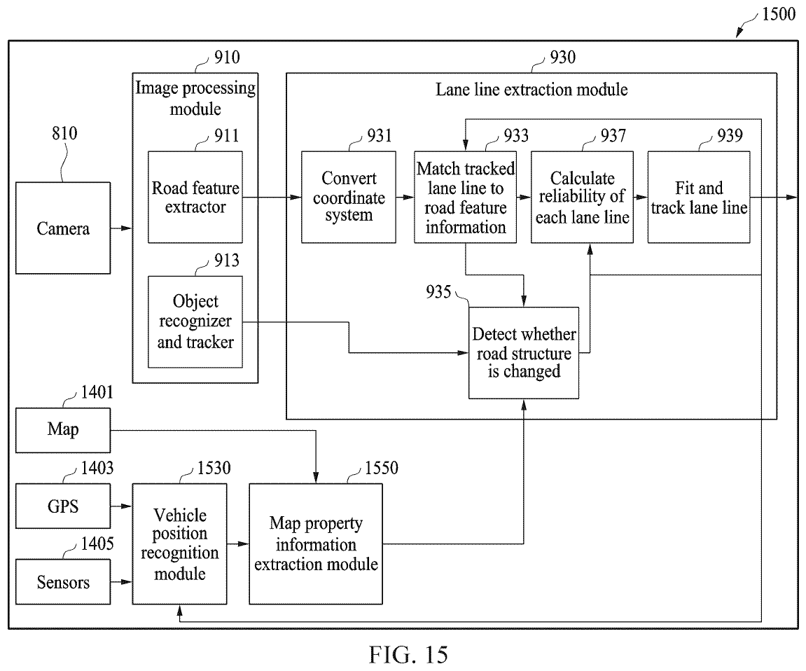

FIG. 15 illustrates an example of a positioning system of an autonomous vehicle. Referring to FIG. 15, a positioning system 1500 using a determination device 900 is illustrated. Hereinafter, a configuration and operation of the positioning system 1500, which are different from those of the determination device 900, are mainly described.

The positioning system 1500 may further include a vehicle position recognition module 1530 and a map property information extraction module 1550, besides a camera 810, an image processing module 910, and a lane line extraction module 930 that are included in the determination device 900.

The lane line extraction module 930 may recognize a position of a vehicle through the operations described above with reference to FIG. 14 and may determine whether a road structure is changed based on map property information of surrounding roads based on the current position of the vehicle obtained by using positioning information calculated through the position of the vehicle.

The vehicle position recognition module 1530 may recognize the position of the vehicle by using lane line information tracked by the lane line extraction module 930 and sensors (e.g., a GPS 1403) included in the vehicle. The vehicle position recognition module 1530 may recognize the position of the vehicle by reflecting the lane line information tracked by the lane line extraction module 930 when recognizing the position of the vehicle by using the sensors (e.g., the GPS sensor 1403 and other sensors 1405) included in the vehicle. For example, the vehicle position recognition module 1530 may measure an absolute position of the vehicle through the GPS sensor 1403 and modify the absolute position of the vehicle by using the moving direction and speed of the vehicle that are measured through an OBD sensor. In addition, the vehicle position recognition module 1430 may measure the movement and direction of the vehicle by further using an acceleration sensor and a gyro sensor.

The map property information extraction module 1550 may extract map property information of surrounding roads based on the current position of the vehicle by using positioning information calculated through the position of the vehicle recognized by the vehicle position recognition module 1430. The map property information of surrounding roads may include a position of a lane line, the number of lane lines, the width of a lane line, the type of a lane line, and the like, but examples are not limited thereto.

The lane line extraction module 930 may detect whether a road structure is changed by further using the map property information extracted by the map property information extraction module 1550.

The determination devices, cameras, processors, output devices, memories, image processing modules, lane line extraction modules, road feature extractors, object recognizers and trackers, map change detection systems, GPS sensors, other sensors, map change detection modules, vehicle position recognition modules, map property information extraction modules, positioning systems, determination device 800, camera 810, processor 830, output device 850, memory 870, determination device 900, image processing module 910, lane line extraction module 930, road feature extractor 911, object recognizer and tracker 913, map change detection system 1400, GPS sensor 1403, other sensors 1405, map change detection module 1410, vehicle position recognition module 1430, map property information extraction module 1450, positioning system 1500, vehicle position recognition module 1530, map property information extraction module 1550, and other apparatuses, devices, and components described and disclosed herein with respect to FIGS. 1-15 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-15 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with lane line determination, the method comprising:
determining, from an input image, road feature information comprising a surrounding object and a road surface marking comprising a lane line;
matching the road feature information to lane lines of a driving road on which a vehicle is driving;
detecting whether there is a change in a road structure based on a result of the matching, wherein the change in the road structure comprises any one or any combination of any two or more of a change of the lane line, a loss of the lane line, and a change of a road sign; and
based on whether the change in the road structure is detected, determining lane line information of the driving road by using information on the surrounding object.

2. The method of claim 1, wherein the determining the road feature information comprises any one or any combination of any two or more of:
extracting features of a road surface comprising the road surface marking;
determining a probability value of each type of the features of the road surface; and
determining either one or both of a position and a speed of the surrounding object comprising a surrounding vehicle that is driving on the driving road.

3. The method of claim 1, wherein the matching comprises:
determining a lane template corresponding to the driving road;
determining a matching score by matching the lane template to the road feature information; and
determining a number of candidate lane lines comprised in the driving road and spacing information between the candidate lane lines, based on the matching score.

4. The method of claim 3, wherein the determining the lane template comprises either one or both of:
determining the lane template based on a curvature range of the candidate lane lines comprised in the driving road; and
determining the lane template based on map information corresponding to the driving road.

5. The method of claim 3, wherein the determining the matching score comprises:
sweeping the lane template into pixels of the candidate lane lines by moving and rotating the lane template; and
determining a matching score of the candidate lane lines based on a number of pixels of the candidate lane lines matching the lane template through the sweeping.

6. The method of claim 1, wherein the detecting whether there is the change in the road structure comprises:
detecting whether there is the change in the road structure by using any one or any combination of any two or more of a number of candidate lane lines comprised in the driving road based on the result of the matching, spacing information between the candidate lane lines, and information on the surrounding object.

7. The method of claim 6, wherein the detecting whether there is the change in the road structure comprises:
determining a first number of lane lines comprised in the driving road from either one or both of navigation information of the vehicle and map information corresponding to the driving road;
determining a second number of candidate lane lines of which a matching score is higher than a reference value among the candidate lane lines; and
detecting whether there is the change in the road structure based on whether there is a difference between the first number of lane lines and the second number of candidate lane lines.

8. The method of claim 6, wherein the detecting whether there is the change in the road structure comprises:
determining the spacing information between the candidate lane lines by using either one or both of map information corresponding to the driving road and width information of a driving lane in which the vehicle is driving; and
detecting whether there is the change in the road structure based on a number of pairs of valid lane lines based on the spacing information.

9. The method of claim 6, wherein the detecting whether there is the change in the road structure comprises:
assigning a penalty value of the candidate lane lines by using the information on the surrounding object comprising a surrounding vehicle, wherein the penalty value corresponds to candidate lane lines among the candidate lane lines in an area in which the surrounding vehicle is positioned; and
based on the penalty value, detecting whether there is the change in the road structure comprising candidate lane lines corresponding to the area in which the surrounding vehicle is positioned.

10. The method of claim 9, wherein the assigning the penalty value comprises:
assigning a penalty value of candidate lane lines of a lane in which the surrounding vehicle is driving, among the candidate lane lines, based on whether a distance between the surrounding vehicle and right and left lane lines among the candidate lane lines of the surrounding vehicle based on a position and width of the surrounding vehicle is within a threshold value.

11. The method of claim 1, wherein the determining the lane line information comprises:
determining the lane line information by using the road feature information and a matching score of candidate lane lines recognized through the matching in response to the change in the road structure not being detected.

12. The method of claim 1, wherein the determining the lane line information comprises:
determining the lane line information by using a penalty value assigned by using the road feature information, candidate lane lines recognized through the matching, and the information on the surrounding object in response to the change in the road structure being detected.

13. The method of claim 12, wherein the determining the lane line information in response to the change in the road structure being detected comprises:
determining reliability of each of the candidate lane lines of the driving road based the penalty value; and
determining, based on the reliability of each of the candidate lane lines, the lane line information of the driving road by fitting the candidate lane lines to lane lines of the driving road.

14. The method of claim 13, wherein the determining the lane line information of the driving road by fitting the candidate lane lines to the lane lines of the driving road comprises:
determining a driving equation corresponding to the driving road based on the reliability of each candidate lane line; and
determining the lane line information by tracking multiple lane lines of the driving road by each lane line by using the driving equation.

15. The method of claim 14, further comprising:
recognizing a position of the vehicle by using sensors comprised in the vehicle;
extracting map property information of the driving road based on a current position of the vehicle from map information by using positioning information determined through the position of the vehicle;
detecting whether there is the change in the road structure in the map information by using the map property information; and
modifying the map information by reflecting the change in the road structure when the change in the road structure is detected.

16. The method of claim 14, further comprising:
recognizing the position of the vehicle by using sensors comprised in the vehicle and the lane line information tracked by each lane line;
extracting map property information of the driving road based on a current position of the vehicle by using the positioning information determined through the position of the vehicle; and
detecting whether there is the change in the road structure by further using the map property information.

17. A non-transitory computer-readable storage medium storing instructions that, when executed by a processor, configure the processor to perform the method of claim 1.

18. An apparatus with lane line determination, the apparatus comprising:
a processor configured to:
determine, from an input image, road feature information comprising a surrounding object and a road surface marking comprising a lane line;
match the road feature information to lane lines of a driving road on which a vehicle is driving;
detect whether there is a change in a road structure based on a result of the matching, wherein the change in the road structure comprises at least one of a change of a lane line, a loss of the lane line, and a change of a road sign; and
determine lane line information by using information on the surrounding object based on whether the change in the road structure is detected.

19. The apparatus of claim 18, wherein, for the detecting whether there is the change in the road structure, the processor is configured to:
detect whether there is the change in the road structure by using any one or any combination of any two or more of a number of candidate lane lines comprised in the driving road based on the result of the matching, spacing information between the candidate lane lines, and the information on the surrounding object.

20. The apparatus of claim 18, wherein, for the determining the lane line information, the processor is configured to perform either one or both of:
determining the lane line information by using the road feature information and a matching score of candidate lane lines recognized through the matching in response to the change in the road structure not being detected; and
determining reliability of each of the candidate lane lines of the driving road by using a penalty value assigned by using the road feature information, the candidate lane lines recognized through the matching, and the information on the surrounding object and determine, based on the reliability of each of the candidate lane lines, the lane line information of the driving road by fitting the candidate lane lines to lane lines of the driving road.
